(19) United States
(12) Patent Application Publication
(10) Pub. No.: US 2026/0350232 A1
(43) Pub. Date: Nov. 5, 2026

(54) AUTHORSHIP AUTHENTICATION SYSTEM

(71) Applicant: Norvalid AS, Kvaløya (NO)

(72) Inventor: Vegar Andreas BERGUM, Tromsø (NO)

(21) Appl. No.: 19/642,426

(22) Filed: Apr. 8, 2026

Related U.S. Application Data
(63) Continuation-in-part of application No. PCT/EP2024/077857, filed on Oct. 3, 2024.
(60) Provisional application No. 63/590,171, filed on Oct. 13, 2023.

(51) Int. Cl. G06F 21/64

(52) U.S. Cl. CPC G06F 21/64

(57) ABSTRACT

A method and system for authenticating authorship comprising receiving a first assignment response from an examinee and generating a question set using an automated question generator. An answer set is received associated with a question. An integrity score is obtained by analyzing the first assignment response for academic integrity. This comprises determining either a first authorship verification score by comparing the first assignment response with a verified assignment response, a plagiarism score associated with detected plagiarized content, or an AI detection score associated with content generated by large language models. An authorship authentication result is then output based on the answer set and integrity score.

### CROSS-REFERENCE TO RELATED APPLICATIONS

The present application is continuation-in-part of International Patent Application No. PCT/EP2024/077857 filed on Oct. 3, 2024, which claims the benefit of U.S. Provisional Application No. 63/590,171 filed on Oct. 13, 2023, each of which is incorporated herein by reference in its entirety.

### TECHNICAL FIELD

Aspects of the present disclosure relate to a system for authenticating authorship. Specifically, but not exclusively, aspects of the present disclosure are directed to a system utilizing a question generator and at least one integrity model for authenticating authorship upon submission of an assessment. Specifically, but not exclusively, aspects of the present disclosure are directed to ensuring the authenticity and integrity of submitted assignments by leveraging advanced computational techniques and data sources to detect ghostwriting.

### BACKGROUND

Ghostwriting in academic and professional settings presents significant technical challenges, particularly in terms of computational resources and system security. Traditional methods of detecting ghostwriting, such as manual review and basic plagiarism detection tools, are not only time-consuming but also resource intensive. These methods often require substantial computational power and storage capacity, making them inefficient and costly. Additionally, the rise of AI-generated content further complicates detection, as it demands advanced algorithms and significant processing power to identify subtle patterns and inconsistencies.

The lack of effective ghostwriting detection tools exacerbates these technical problems. Current systems are not equipped to handle the computational demands of combating modern ghostwriting practices, leading to inefficiencies and increased power consumption. Plagiarism detection tools primarily focus on identifying copied content but do not address the issue of verifying whether the examinee is the true author of the work. This gap necessitates the development of more sophisticated methods that can operate efficiently without compromising accuracy.

One example of prior art is Authorship verification via cloze-test, a master’s thesis by Tomáš Kancko, which describes using cloze-tests for identifying instances of ghostwriting, where words are removed from a text and a user must guess the correct words. However, these known methods focus primarily on identifying content words that distinguish an author's style and faces limitations in scalability and energy efficiency due to complex model training and inference.

There is a pressing need for advanced authorship authentication systems that can accurately and efficiently verify the authenticity of submissions. The development of these systems is crucial for maintaining the credibility of educational assessments and ensuring that examinees are evaluated fairly and accurately, without requiring extensive invasive monitoring and excessive computational resources.

### SUMMARY

According to an aspect of the present disclosure, there is provided a method for authenticating authorship. The method comprises, within a first response session, receiving a first assignment response associated with an examinee and generating, using an automated question generator, a question set based on the first assignment response. The question set comprises one or more questions, which are communicated to the examinee. An answer set, associated with at least one of the questions, is received in response. The answer set is provided by the examinee and received within the first response session. An integrity score is obtained based on analysing the first assignment response for academic integrity. Either a first authorship verification score, a plagiarism score, or an AI detection score is determined when obtaining the integrity score. The first authorship verification score is based on comparison of the first assignment response with a verified assignment response authored by the examinee. The plagiarism score is associated with a level of plagiarised content detected within the first assignment response. The AI detection score is associated with the level or likelihood of content within the first assignment response being generated using one or more large language models. An authorship authentication result associated with the answer set and integrity score is output for determining whether the examinee authored the first assignment response.

According to an additional aspect of the present disclosure, determining the first authorship verification score comprises extracting a first feature value associated with a target feature from the first assignment response, extracting a second feature value associated with the target feature from the verified assignment response, and comparing the first feature value to the second feature value.

According to an additional aspect of the present disclosure, determining the first authorship verification score further comprises determining a second authorship verification score, wherein the second authorship verification score is based on comparison of the first assignment response with the answer set.

According to an additional aspect of the present disclosure, the first authorship verification score is determined using a linguistic analysis model trained using one or more historical assignment responses.

According to an additional aspect of the present disclosure, the linguistic analysis model comprises a plurality of collaborative machine learning models.

According to an additional aspect of the present disclosure, the plagiarism score is determined by comparing the first assignment response to one or more works stored on a database.

According to an additional aspect of the present disclosure, the automated question generator is configured to output one or more questions relevant to an input, and wherein the input comprises any of: the first assignment response, an academic or scientific reference, subject matter associated with the first assignment response, curriculum data, a historical assignment response, or any combination thereof.

According to an additional aspect of the present disclosure, the automated question generator comprises a generative machine learning model.

According to an additional aspect of the present disclosure, the one or more questions of the question set are generated in real-time or near real-time.

According to an additional aspect of the present disclosure, the question set is communicated to the examinee within a first predetermined time interval, e.g. within 10 seconds of receiving the first assignment response.

According to an additional aspect of the present disclosure, an answer of the answer set is received within a second predetermined time interval, e.g. within 5 seconds after the question set is generated or submitted.

According to an additional aspect of the present disclosure, the method further comprises performing an analysis of the answer set and, based on the analysis, choosing whether to determine the first authorship verification score, the plagiarism score, or the AI detection score.

According to an additional aspect of the present disclosure, obtaining the integrity score comprises determining any combination of the first authorship verification score, the plagiarism score, or the AI detection score.

According to another aspect of the present disclosure, the above described methods are performed at an authentication device.

According to another aspect of the present disclosure, the automated question generator utilises the integrity score to generate a question set. Such utilising may comprise the automated question generator modulating at least one characteristic of questions in the generated question set in accordance with the integrity score. The characteristic may comprise question quantity and question complexity.

In another aspect of the present disclosure, the utilising comprises the automated question generator focussing question generation on sections of the assignment response shown when obtaining the integrity score to have high levels of plagiarism or high likelihood of ai-generated content.

According to another aspect of the present disclosure, there is provided a non-transitory or transitory computer-readable medium storing instructions for performing the method of any previously disclosed aspect.

According to another aspect of the present disclosure, there is provided an authorship authentication system configured to output an authorship authentication result for determining whether an examinee authored a first assignment response. The authorship authentication system comprises an automated question generator and one or more integrity models. The automated question generator is configured to generate a question set comprising one or more questions, where the question set is associated with the first assignment response submitted by the examinee. Also, the question set is provided to the examinee within a predetermined time interval after the authorship authentication system receives the first assignment response. The one or more integrity models are configured to obtain an integrity score, wherein the integrity score is based on analysing the first assignment response for academic integrity. The one or more integrity models comprise any of: an authorship verification model configured to determine a first authorship verification score based on comparison of the first assignment response with a verified assignment response authored by the examinee; a plagiarism model configured to determine a plagiarism score associated with a level of plagiarised content detected within the first assignment response; or an AI detection model configured to determine an AI detection score associated with the level or likelihood of content within the first assignment response being generated using one or more large language models.

Beneficially, the above aspects leverage an automated question generator and any one or more integrity models to analyse submissions for academic integrity. By generating questions based on the content of the submission and requiring the examinee to answer them, the system can verify authorship in real-time. The integrity models further enhance the system's capabilities by providing scores for authorship verification, plagiarism detection, and AI content detection, ensuring a thorough and accurate assessment of the submission's authenticity while optimising computational resources.

Combining real-time and near-real time question generation with authorship verification, plagiarism detection, or AI content detection provides an inventive improvement over the prior art by offering more dynamic, context-aware evaluation while saving computational resources and energy. Unlike the static cloze-test model described in the prior art, real-time question generation adjusts dynamically based on the text and user responses, providing a more accurate and efficient evaluation. This reduces the need for complex model retraining or high computational overhead, as the system adapts in real-time, optionally minimizing resource-intensive batch processing of entire texts.

Additionally, integrating this with authorship verification, plagiarism detection, or AI content detection enables a holistic approach that targets multiple layers of content authenticity simultaneously. It improves system efficiency by narrowing down suspicious sections of the text before deeper analysis, thereby reducing unnecessary computations. This combination can be computationally optimized, as it minimizes redundant operations by leveraging shared features across these detection mechanisms, significantly saving processing power and energy in contrast to traditional, isolated systems like the cloze-test method.

The skilled person will understand that any above-described apparatus, process, system, and method is not limited to authorship authentication and may be applied to alternative contexts and usage scenarios. For example, harmonising works with multiple authors or verifying content sources.

### BRIEF DESCRIPTION OF DRAWINGS

Embodiments will now be described, by way of example only, and with reference to the accompanying drawings, in which:

FIG. 1 illustrates a system architecture diagram for integrity analysis;

FIG. 2 illustrates a system architecture diagram for question generation;

FIG. 3 illustrates a system architecture diagram for authorship authentication;

FIG. 4 shows a flowchart illustrating a process for authorship identification;

FIG. 5 shows a flowchart illustrating a method for authorship identification; and

FIG. 6 shows an example computing environment for performing any of the methods described herein.

All illustrations of the drawings are for the purpose of describing selected embodiments and are not intended to limit the scope of the protection.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure.

Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure. Accordingly, while embodiments are described herein in detail in relation to one or more embodiments, it is to be understood that this disclosure is illustrative and exemplary of the present disclosure, and are made merely for the purposes of providing a full and enabling disclosure.

The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail. Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present disclosure contains headers. It should be understood that these headers are used as references and are not to be construed as limiting upon the subjected matter disclosed under the header. Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description.

The present disclosure includes many aspects and features. Moreover, while many aspects and features relate to, and are described in the context of an authorship authentication system, embodiments of the present disclosure are not limited to use only in this context. In the context of the present disclosure any systems, methods or processes disclosed herein comprise an at least one processing unit whereby said at least one processing unit performs the process.

### DETAILED DESCRIPTION

Embodiments of the present disclosure will now be described with reference to the attached figures. It is to be noted that the following description is merely used for enabling the skilled person to understand the present disclosure, without any intention to limit the applicability of the present disclosure to other embodiments which could be readily understood and/or envisaged by the reader. In particular, whilst the present disclosure is primarily directed to an authorship authentication system, the skilled person will appreciate that the apparatus, processes, methods and systems described herein are applicable to detecting ghostwriting or determining harmony between authored works more broadly. For example, content authenticity verification in journalism and reporting, or software harmonisation across one or more developers.

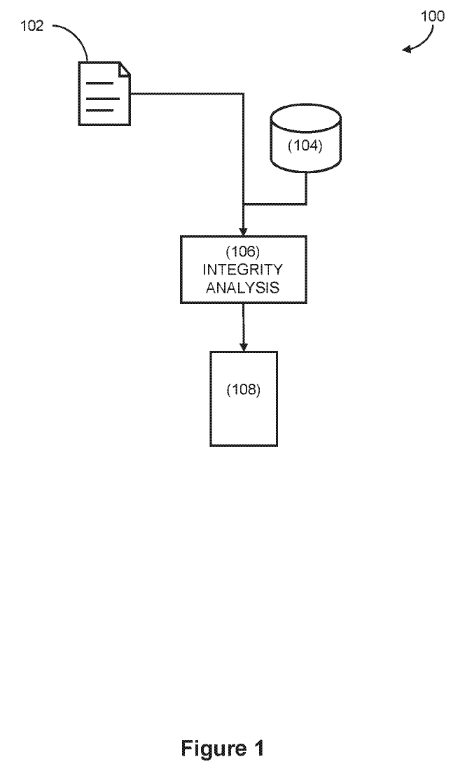

The present disclosure describes an authorship authentication system, as illustrated in FIGS. 1-6. This system analyses submissions from an examinee on behalf of an assessment body, and includes a question generator and at least one integrity model. The question generator produces questions related to the submission's content, which the examinee must answer within a predetermined time, e.g. within a live response session. This generator uses various potential techniques, including statistical language models, natural language processing, or machine learning, to create questions for authenticating authorship. The integrity model processes and analyses the submissions, using methods like authorship verification, plagiarism detection, and AI detection.

Ghostwriting poses significant risks to both systems and individuals. In computing systems, ghostwritten content can be used to bypass security protocols, deceive machine learning models, or propagate malicious software disguised as legitimate documentation or communication. For individuals, ghostwritten content can lead to the spread of misinformation, academic dishonesty, and even legal repercussions if falsely attributed work is used in critical decision-making processes. Detecting ghostwriting thus serves as a protective measure, ensuring that systems are not compromised by deceptive content and that people are not misled by false information. By validating the true authorship of content, ghostwriting detection enhances the reliability and security of digital communications and information systems.

Detecting ghostwriting, e.g. using computational techniques and algorithms, addresses the challenge of identifying content that has been produced by an entity other than the purported author, such as a different person or a generative computational system. Ghostwriting detection using the authorship authentication methods and systems described herein leverages natural language processing (NLP), machine learning, or other data-driven methods to analyse text for inconsistencies in style, vocabulary, and authorship. This approach provides a technical means to resolve the technical problem of ensuring the authenticity and integrity of written content across digital platforms, where fraudulent or deceptive authorship can lead to security vulnerabilities and misinformation.

The embodiments described herein ensure efficient handling and verification of various types of submissions, optimizing data handling and storage. By generating a dynamic question set using an automated question generator, the system reduces the need for extensive manual or computational review, conserving both time and computational resources. Real-time interaction through receiving an answer set from the examinee adds an additional layer of verification, minimizing the need for extensive post-processing. The comprehensive analysis for obtaining an integrity score includes any of authorship verification, plagiarism detection, or AI content detection, providing a multi-faceted approach to assessing academic integrity while optimizing the use of computational methods and algorithms, improving efficiency of integrity analysis. Outputting a clear and actionable authorship authentication result streamlines the decision-making process, reducing computational overhead further still.

Described embodiments also improve the accuracy of authorship verification by comparing specific features of the submission with verified responses, leveraging machine learning models trained on historical responses to detect inconsistencies efficiently. Additionally, comparing the submission to a database for plagiarism detection ensures reliable identification of copied content while optimizing database queries. The flexibility of the automated question generator to use various inputs enhances the system's security by generating relevant and challenging questions, helping prevent fraudulent answering, e.g. by using LLMs. Using a generative machine learning model for question generation ensures contextually relevant questions, optimizing computational efficiency. Generating questions within a predetermined time interval and receiving answers in real-time or near real-time further strengthen the verification process, reducing the need for extensive post-processing. Scalability and ease of deployment are enhanced by storing instructions on a non-transitory computer-readable medium, while the integration of multiple verification methods provides a robust solution to ghostwriting, optimizing computational resources.

For example, the authorship authentication system analyses a series of one or more submissions from an examinee on behalf of an assessment body. The system comprises a question generator and an at least one integrity model, e.g. a cheating detection model. The assignment body receives the submitted response to the assessment, wherein the assessment is processed and analysed by the at least one integrity model. According to one embodiment of the present disclosure, the at least one integrity model is selected from the group comprising of an authorship verification model, a plagiarism detection model, an artificial intelligence (AI) detection model, and a cheating detection model of the like.

According to the above example, the assessment body is an entity that assigns an assessment requiring a submission response. The assessment body, in some embodiments, may comprise a school, a university, a testing agency, an exam board, or an entity of the like. Furthermore, the examinee, in the context of the above example, is an entity that produces the response for submission. A submission, in the context of the above example, is either a digital or analogue content comprising at least one of text, audio, video, and content that is capable of being digitally transcribed into text. The transcription of text from the content is not required to be an exact transcription, but rather the transcription may comprise a shortened or abstracted description of the content.

Further to the above example, integrity analysis is performed using the integrity model. The authorship verification model comprises a system that compares an at least one historic examinee response with the submitted examinee assessment response to determine the likelihood that the responses have been authored by the same entity. Additionally, as in the context of the present disclosure, the plagiarism detection model is a system that utilizes a database of historical responses, web content, and literature references, in comparison to the submitted examinee response to the assessment, to identify presence of plagiarism. Lastly, within the context of the present disclosure, the AI detection model, is a system whereby the examinee submission response is analysed to determine the presence of AI generated content. In some embodiments, the at least one cheating detection model will then formulate a report indicating a metric for determining likelihood of authorship authentication.

Additionally, the question generator produces and communicates an at least one question to the examinee, preferably simultaneously to integrity analysis being performed. The question generator generates questions from the examinee submission response to the assessment. In this example, the questions are associated with the content of the assessment, e.g. the question generator may communicate questions to the examinee pertaining to metadata of the submission response, such as questions about the title of the submission. The system will then give the examinee a predetermined time period to produce answers to the questions generated by the question generator.

According to the above example, the question generator is an electronic or digital system capable of producing questions from an at least one source, e.g. using techniques including any of statistical language models, natural language processing, computational linguistics, neural networks, first-order logic, second-order logic, predefined rulesets, machine learning, artificial intelligence, or a different technique not disclosed here. The at least one source may include textual content such as articles, books, web pages, and essays; multimedia including images, audio, and video; and instructions.

Upon receiving the examinee’s answers, the answers are optionally analysed. For example, the resulting questions from the question generator have, through the use of Item Response Theory (IRT) and Psychometric measurements, observable latent attributes describing the question's performance in discriminating between authentic and inauthentic authorship. The questions will have latent difficulty and discrimination parameter values such that a standard logistic Item Response Function (IRF, as derived from Item response theory) will give the probability that an honest examinee, who is the authentic author of the assignment response, will answer the questions correctly. When measuring the difficulty and discrimination of the questions, the resulting values conclude that an authentic author has a higher likelihood of answering the questions correctly, when applying the Item response function.

FIG. 1 illustrates a system architecture diagram for integrity analysis. Specifically, FIG. 1 illustrates an integrity analysis system 100 for reporting on examinee integrity.

The integrity analysis system 100 is directed towards determining the authenticity and integrity of submitted assignments, e.g. received assignment response 102. The system comprises several interconnected components: a received assignment response 102, a database 104, an integrity analysis unit 106, and an integrity output 108. The received assignment response 102 serves as the input to the integrity analysis unit 106, which processes the assignment to generate an integrity output 108, such as a report or an integrity score. The database 104 contains various data sources necessary for calculating the integrity score associated with the received assignment response 102, ensuring a comprehensive analysis.

The integrity analysis unit 106 uses computational techniques to evaluate the received assignment response 102, such as natural language processing, feature tokenisation, and/or machine learning. Integrity analysis unit 106 is any integrity model described herein, including authorship verification model, plagiarism detection model, or AI content detection model, to assess the assignment's authenticity. For example, the authorship verification model compares the received assignment with verified historical responses from the same examinee, extracting and comparing feature values to determine consistency. This process is optionally enhanced by machine learning models trained on historical data, ensuring accurate and reliable verification.

The database 104 supports the integrity analysis unit 106. Database 104 stores data comprising any of: historical assignment responses, web content, literature references for plagiarism detection, or other relevant works not listed here. By comparing the received assignment response 102 against these stored works, the integrity analysis system 100 identifies content likely to have been authored by the examinee, thereby ensuring the originality of the submission. Additionally, or alternatively, the database 104 supports the AI detection model by providing reference data to identify content generated by large language models, further safeguarding against fraudulent submissions.

The integrity output 108 preferably provides a user of the integrity analysis system 100 with a clear and actionable result based on the analysis performed by the integrity analysis unit 106, associated with the honesty and/or integrity of the examinee who submitted the received assignment response 102. This integrity output 108 optionally includes an integrity score, which quantifies the likelihood of the assignment being authentic, or a report highlighting any detected issues, such as plagiarism or AI-generated content. This comprehensive output enables assessment bodies to make informed decisions regarding the authenticity of the submission, thereby maintaining academic integrity and preventing academic dishonesty.

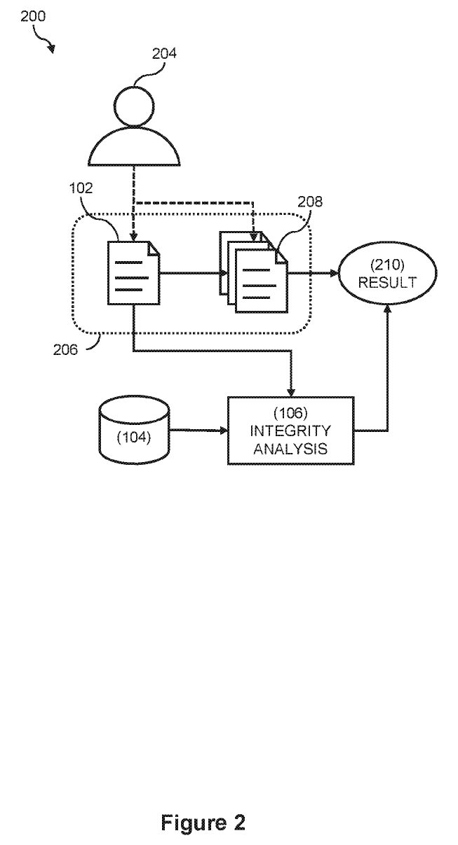

FIG. 2 illustrates a system architecture diagram for question generation. Specifically, FIG. 2 illustrates an authorship authentication system 200 utilising integrity analysis unit 106 in combination with question generation.

The authorship authentication system 200 comprises several interconnected components: an assignment (not depicted), an examinee 204, a submission session 206, a received assignment response 102, an answer set 208, a database 104, an integrity analysis unit 106, and a result 210. The authorship authentication system 200 is configured to verify the authenticity of submitted assignments by determining whether the examinee 204 is the true author of the received assignment response 102.

Upon receiving the assignment response 102 from the examinee 204, a submission session 206 is initiated and a question set is generated based, at least in part, on the received assignment response 102. The examinee 204 then answers the question set, thereby generating an answer set 208. The received assignment response 102 is input, e.g. subsequently or simultaneously, to the integrity analysis unit 106, where the output of the integrity analysis unit 106 is combined with the answer set 208 to authenticate whether the examinee 204 authored the received assignment response 102, resulting in the result 210.

Optionally, the answer set 208 comprises an answer associated with the examinee not answering any of the questions of the question set. Alternatively, the answer set 208 comprises one or more answers. For example, the answer set 208 comprises an answer associated with one question of the question set, or the answer is associated with more than one question of the question set. In this example, the examinee 204 provides an answer that corresponds to at least one question. In another example, the examinee 204 provides at least one answer for a question, such that one question results in one or more answers. The answer set 208 comprises written, oral, or other forms of communication with the authorship authentication system 200.

The result 210 preferably comprises the integrity output 108 (see FIG. 1). This result 210 optionally includes an integrity score, which quantifies the likelihood of the assignment being authentic, and/or a report highlighting any detected issues, such as plagiarism or AI-generated content. The result 210 combines the output of the integrity analysis unit 106 with the answer set 208, providing a more comprehensive and multi-faceted authentication of the examinee's authorship. This integration allows for a more accurate determination of authenticity by cross-referencing the examinee's real-time responses with the integrity analysis, thereby enhancing the reliability and robustness of the authorship verification process. For example, result 210 is an authorship authentication result associated with the answer set and the integrity score, output by authorship authentication system 200 for determining whether the examinee authored the first assignment response.

Using result 210 allows for near-instant honesty verification, enabling real-time assessment of the examinee's responses. By providing instant feedback and verification, the authorship authentication system 200 minimizes the computational resources required for separate, sequential analyses, thereby improving overall efficiency. This real-time approach ensures that any discrepancies or issues can be addressed promptly, streamlining the decision-making process and maintaining high standards of authorship integrity.

For example, authorship authentication system optionally acts as a written, preferably computational written, or oral Viva, wherein knowledge of the examinee 204 in relation to the assignment response 102 is assessed.

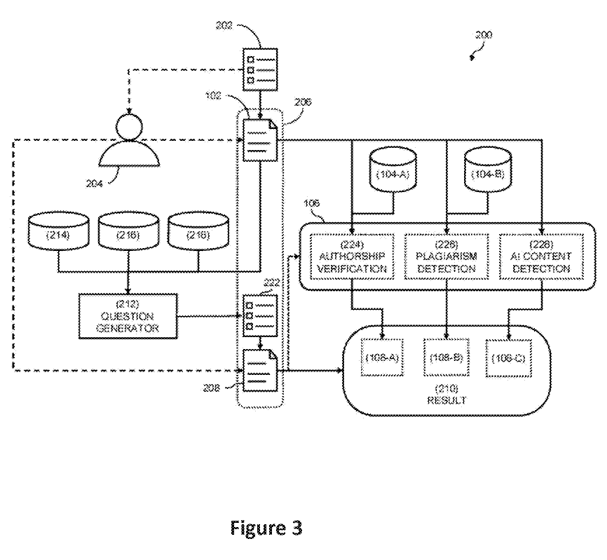

FIG. 3 illustrates a system architecture diagram for authorship authentication. Specifically, FIG. 3 illustrates a preferred embodiment of authorship authentication system 200.

Authorship authentication system 200 comprises: assignment response 102, database 104, integrity analysis unit 106, report 108, assignment 202, examinee 204, submission 206, answer set 208, result 210, question generator 212, first data source 214, second data source 216, third data source 218, question set 222, authorship verification model 224, plagiarism detection model 226, and AI detection model 228.

The authorship authentication system 200 is designed to verify the authenticity of submitted assignments by determining whether the examinee 204 is the true author of the received assignment response 102. The authorship authentication system 200 comprises several interconnected components. The assignment 202 is the task or set of questions provided to the examinee 204, which forms the basis of the received assignment response 102. The assignment response 102 is the submission provided by the examinee 204 in response to the assignment 202 and serves as the primary input for the integrity analysis unit 106 and question generator 212. The database 104 stores various data sources necessary for the integrity analysis, including historical assignment responses, web content, and literature references, which support the integrity analysis unit 106 in performing plagiarism detection and AI content detection.

The examinee 204 is the individual who completes the assignment 202 and submits the assignment response 102. They also participate in the submission session 206, where they answer questions generated by the question generator 212. The submission 206 refers to the process where the examinee 204 submits the assignment response 102 and participates in a session where a question set 222 is generated based on the received assignment response 102. The answer set 208 comprises the answers provided by the examinee 204 in response to the question set 222 generated by the question generator 212. This answer set 208 is used in conjunction with the integrity analysis output to authenticate the authorship of the assignment response 102. The result 210 is the final output of the system, combining the integrity analysis output with the answer set 208 to determine whether the examinee 204 authored the received assignment response 102. This result optionally comprises an integrity score and a detailed report highlighting any detected issues.

The question generator 212 generates a question set 222 based on the received assignment response 102, using techniques such as statistical language models, natural language processing, and machine learning to create relevant questions for the examinee 204 to answer. The question set 222 is therefore tailored for each assignment response 102 received at authorship authentication system 200. The first data source 214, second data source 216, and third data source 218 provide additional information and context for the question generator 212 and the integrity analysis unit 106, including academic references, subject matter data, and historical assignment responses. For example, the first data source 214 is a first database comprising references to works, second data source 216 is a second database comprising data and information associated with curriculum or the purpose of assignment 202, and/or third data source 218 is a third database comprising subject matter associated with assignment 202 or received assignment response 102. The question generator accesses data, information, and/or documents of first data source 214, second data source 216, and third data source 218 to generate relevant questions. Alternatively, or additionally, first data source 214, second data source 216, or third data source 218 are used as training data for question generator 212.

Preferably, question generator 212 comprises a generative machine learning model, capable of generating one or more questions based on inputs comprising the assignment response 102 and, optionally, any data of first data source 214, second data source 216, or third data source 218.

The authorship verification model 224 compares the received assignment response 102 with verified historical responses from the same examinee 204, extracting and comparing feature values to determine consistency. For example, one or more verified historical response from examinee 204, e.g. a work known to have been authored by the examinee 204, is stored in database 104-A and accessible as an input to authorship verification model 224. Optional implementation is described further in relation to method 500, specifically step 506, below.

The plagiarism detection model 226 compares the received assignment response 102 against data stored in the database 104.B, e.g. historical works authored by the examinee 204 or other authors, to identify any plagiarized content, ensuring the originality of the submission.

The AI detection model 228 analyses the received assignment response 102 to determine the presence of AI-generated content, optionally using reference data from any of the database 104, first data source 214, second data source 216, third data source 218, or assignment 202 to identify content likely generated by large language models.

The integrity analysis unit 106 processes the received assignment response 102 using any one of the authorship verification model 224, plagiarism detection model 226, or AI detection model 228 to assess the assignment's authenticity. The result 210 optionally provides a detailed analysis of the received assignment response 102, including an integrity score and highlighting any detected issues, e.g. outlined in report 108, enabling assessment bodies to make informed decisions regarding the authenticity of the submission. Rather than always using multiple models, which is computationally resource heavy and inefficient relative to time and energy, only one model is required. Generating questions is less resource intensive than running multiple models, especially regarding data-rich/large assignment responses. Therefore, the combination of a submission session 206 in combination with integrity analysis provides multiple efficiency savings and improves scalability of authorship authentication.

According to one embodiment, a selection of the authorship verification model 224, plagiarism detection model 226, or AI detection model 228 used in integrity analysis is based on the answer set 208. For example, if the answer set 208 is associated with a session score below a session threshold or otherwise indicative of further honesty verification, a model is selected. Optionally, the selected model is the most relevant model. Further optionally, the selected process is based on a selection protocol, e.g. one or more models are used in a predefined series. Selection processes further improve efficiency without impacting accuracy of authorship authentication, as computationally extensive procedures are limited based on the integrity requirements of each submission.

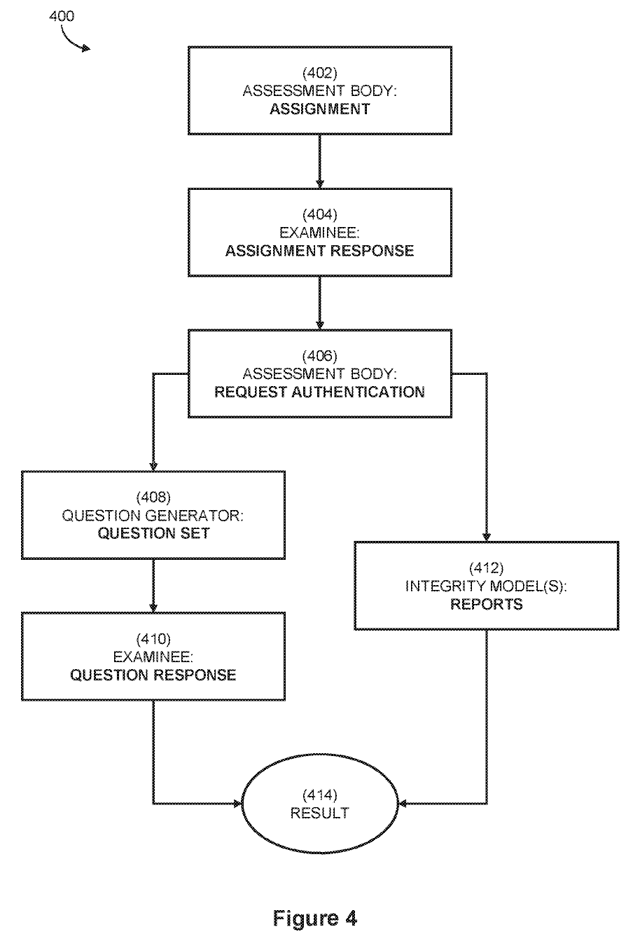

FIG. 4 shows a flowchart illustrating a process for authorship identification. Specifically, FIG. 4 illustrates a process 400 for using authentication system 200 as described in relation to FIGS. 2 and 3.

Process 400 comprises steps 402-414 as detailed below.

Step 402 “Assignment body: Assignment” comprises an assignment 202 being generated by an assignment body, where the assignment 202 is accessible by an examinee 204 for completion. For example, step 402 comprises the generation of an assignment 202 by an assignment body, such as a school, university, testing agency, or exam board. The assignment 202 is designed to assess the knowledge and skills of the examinee 204 and is made accessible to them for completion. The assignment body ensures that the assignment 202 is relevant to the curriculum and includes questions or tasks that require thoughtful responses. This step sets the stage for the subsequent steps by providing the initial task that the examinee 204 must complete and submit for evaluation.

Step 404 “Examinee: Assignment response” comprises the examinee 204 providing an assignment response 102 associated with the assignment 202 of step 402. For example, according to step 404, the examinee 204 completes the assignment 202 and provides an assignment response 102. This response is the examinee's attempt to answer the questions or fulfil the tasks outlined in the assignment 202. The assignment response 102 is then submitted to the assessment body for evaluation. This step obtains the examinee's work, which will later be analysed for authenticity and integrity. Optionally, the quality and originality of the assignment response 102 impact the subsequent authentication process, e.g. where integrity model selection protocols are used.

Step 406 “Assessment body: Request authentication” comprises the assessment body initiating a submission session 206, where the assessment body requires authentication of examinee authorship of the received assignment response 102. For example, step 406 comprises the assessment body initiating a submission session 206 to request authentication of the examinee's authorship of the received assignment response 102. This step is triggered when the assessment body needs to verify that the assignment response 102 was genuinely authored by the examinee 204. The submission session 206 sets the framework for the authentication process, ensuring that the necessary steps are taken to validate the authorship and integrity of the submitted work. This step helps maintain academic integrity and prevents dishonest practices such as ghostwriting or plagiarism.

Step 408 “Question generator: Question set” comprises generating a question set 222 using the question generator 212, where the questions are associated with the assignment response 102 and, optionally, data associated with the assignment 202. For example, according to Step 408, a question set 222 is generated using the question generator 212. The questions in the set are associated with the assignment response 102 and may also be related to data associated with the assignment 202. The question generator 212 employs techniques such as statistical language models, natural language processing, and machine learning to create relevant and challenging questions. These questions are designed to probe the examinee's understanding of the assignment response 102 and, optionally, associated content or topics, and therefore ensure that the examinee is the true author of the assignment response 102. This step adds an additional layer of verification by requiring the examinee 204 to answer questions related to their submission.

Step 410 “Examinee: Question response” comprises the examinee 204 providing an answer set 208 of one or more answers corresponding to the one or more questions of the question set 222. For example, step 410 comprises the examinee 204 providing an answer set 208, which consists of one or more answers corresponding to the questions in the question set 222. The examinee 204 optionally must respond to these questions within a predetermined time frame, ensuring that their answers are spontaneous and reflective of their knowledge associated with the content of the assignment response. The answer set 208 is then used in conjunction with the integrity analysis to authenticate the authorship of the assignment response 102. This step is essential for verifying the examinee's familiarity with the content of their submission and detecting any inconsistencies that may indicate dishonesty.

Step 412 “Integrity model(s): Reports” comprises one or more integrity models outputting reports 108 associated with authorship integrity of the assignment response 102, where the output comprises an integrity score. For example, according to step 412, one or more integrity models output reports 108 associated with the authorship integrity of the assignment response 102. These reports include an integrity score, which quantifies the likelihood that the assignment response 102 is authentic. The integrity models, such as authorship verification, plagiarism detection, and AI content detection models, analyse the assignment response 102 and the answer set 208 to identify any discrepancies or signs of fraudulent authorship. This step provides a comprehensive analysis of the submission, ensuring that the assessment body has all the necessary information to make an informed decision.

Step 414 “Result” comprises a result associated with the answer set 208 of step 410 and the integrity score of step 412. For example, this result 210 provides a clear and actionable outcome regarding the authenticity of the assignment response 102. It optionally includes a detailed report highlighting any detected issues, such as plagiarism or AI-generated content, and an overall integrity score. This final step enables the assessment body to make informed decisions about the examinee's submission, ensuring academic integrity and preventing dishonest practices.

Beneficially, recording and monitoring such as screen monitoring, cameras, microphones, or other invasive practices are not required to ensure authorship for each assignment response. This not only saves computational resources and improves the efficiency of remote examination systems, but provides safe, accurate alternatives to in-person examination without decreasing accuracy of authorship authentication.

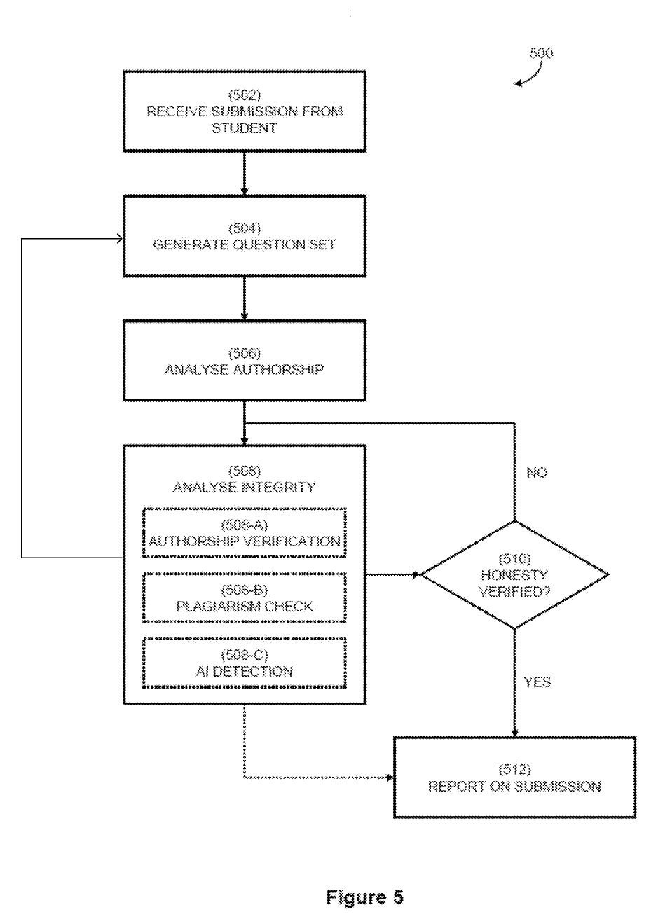

FIG. 5 shows a flowchart illustrating a method for authorship identification. Specifically, FIG. 5 illustrates method 500 for authorship authentication, e.g. using authorship authentication system 200 of FIGS. 2 and 3.

Method 500 comprises: step 502, receive submission from student; step 504, generate question set; step 506, analyse authorship; step 508, analyse integrity; step 510, verify honesty; and step 512, report on submission.

Step 502 comprises, within a first response session, receiving a first assignment response associated with an examinee. Receiving the first assignment response, e.g. assignment response 102, is the initial input for the authentication process and is typically provided by the examinee in response to an assignment or assessment task. The received assignment response is optionally stored and prepared for further analysis. Preferably, the first response session is initiated by an examinee submitting the first assignment response.

Optionally, step 502 comprises initiating a first response session, which comprises submission of a first assignment response and submission of an associated answer set by an examinee. For example, the first response session is configured so the examinee who submits the first assignment response provides answers to the question set generated in step 504 below. Preferably, the first response session is configured so the examinee who submits the first assignment response has to provide at least one answer to, or interaction with, the question set. Further preferably, the first response session is configured to help prevent a user who is not the examinee from answering or interacting with the question set.

Step 504 comprises generating a question set using an automated question generator. For example, the question set 222 is generated by question generator 212. The question set is based on the first assignment response and comprises one or more questions designed to probe the examinee's understanding and authorship of the submitted work. The question generator optionally employs techniques such as statistical language models, natural language processing, or machine learning to create relevant and challenging questions. The one or more questions of the question set are tailored to the content of the assignment response, ensuring that they are specific and contextually appropriate.

Optionally, the question generator is an automated question generator configured to generate questions with minimal human input beyond the submission of the first assignment response in step 502. For example, the automated question generator is configured to output one or more questions relevant to an input, and where the input comprises any of: the first assignment response; an academic or scientific reference; subject matter associated with the first assignment response; curriculum data; a historical assignment response; or any combination thereof. Preferably, the automated question generator comprises a generative machine learning model, or otherwise interacting with a generative machine learning model to obtain questions based on an input associated with the first assignment response. For example, the first assignment response is input to a large language model, which outputs a question set based on the first assignment response.

The automated question generator is optionally configured to generate one or more questions of the question set within a predetermined time interval after receiving the first assignment response, e.g. near-real time. Preferably, answers must also be provided within a second predetermined time interval. The use of time intervals or other timing thresholds helps guarantee honest answers from the examinee, and helps prevent use of fraudulent answering methods. For example, the predetermined time interval is 5 seconds or less.

Step 504 optionally further comprises communicating the question set to the examinee. For example, step 504 comprises submitting, transmitting, or otherwise providing the question set to the examinee. In one example, one or more questions are provided to the examinee in series, interspersed with one or more answers, or an indication of no answer such as exceeding a time limit available for answering, from the examinee. In another example, a plurality of questions are provided to the examinee in parallel, and the examinee may choose to provide one, more than one, or all corresponding answers. Optionally, one or more questions are communicated via sound, e.g. spoken questions via a human or mechanical speaker. Additionally, or alternatively, one or more questions are communicated via sight, e.g. displayed questions such as written questions via a display.

Step 506 comprises analysing authorship, which can be performed before, after, or simultaneously with step 508. Analysing authorship comprises receiving an answer set, e.g. answer set 208, comprising one or more answers provided by the examinee, wherein each answer corresponds to a question of the question set of step 504. Optionally, after the answer set is received, the answers are compared to the first assignment response to determine authorship of first assignment response. For example, step 506 comprises determining how likely it is that the examinee who submitted the first assignment response and provided the answer set authored the first assignment response. Alternatively, or additionally, the answer set is provided in step 512 without further analysis.

Optionally, step 506 comprises using IRT or Psychometric measurements on the answer set to determine the probability of the examinee being the author of the first assignment response, where the answer set corresponds to a questions set comprising one or more questions based on the first assignment response. IRT is a statistical framework used to model the relationship between latent traits of the examinee (such as ability or proficiency) and their item responses, e.g. the one or more answers of the answer set. For example, if the examinee claims to have authored the first assignment response, IRT can be used to assess their responses to questions about the first assignment response’s content, e.g. methodology and underlying theories. If their responses consistently align with the expected difficulty and discrimination parameters of the questions, it suggests a high likelihood of authorship. Psychometric measures, on the other hand, involve the use of standardized tests and assessments to evaluate cognitive abilities, personality traits, and other psychological attributes. For instance, a psychometric based question measures the examinee’s familiarity with specific terminologies, writing style, and conceptual understanding related to the first assignment response. By comparing these measures with known characteristics of the work and the examinee, e.g. via the verified assignment response, one can infer the probability of the examinee being the true author. Together, IRT and psychometric measures provide a robust, evidence-based approach to authorship verification.

The probability of the examinee being the author is optionally calculated based on: how difficult it would be to answer a question of the question set if the examinee did not author the first assignment response, how easy it would be to answer a question if the examinee authored the first assignment response, how easy it would be to guess an answer correctly, or other statistical metrics.

Step 508 comprises analysing the authorship of the first assignment response, thereby obtaining an integrity score. Obtaining an integrity score is based on analysing the first assignment response for academic integrity by determining at least one of: a first authorship verification score based on comparison of the first assignment response with a verified assignment response authored by the examinee, e.g. step 508-A; a plagiarism score associated with a level of plagiarised content detected within the first assignment response, e.g. step 508-B; or an AI detection score associated with the level or likelihood of content within the first assignment response being generated using one or more large language models, e.g. step 508-C.

For example, step 508 optionally comprising 508-A includes comparing the first assignment response with verified historical responses authored by the same examinee using an authorship verification model to obtain an authorship verification score. The analysis includes extracting and comparing feature values to determine consistency and identify any discrepancies that may indicate fraudulent authorship. Machine learning models trained on historical data are optionally used to improve the accuracy and reliability of the authorship verification process.

Determining the first authorship verification score optionally comprises extracting a first feature value associated with a target feature from the first assignment response. A second feature value associated with the target feature is extracted from the verified assignment response, and the first feature value is compared to the second feature value, e.g. to determine the likelihood that both the first assignment response and verified assignment response were authored by the same person. Optionally, multiple target features are used.

Target features for a text-based document include any of: lexical choices, e.g. vocabulary usage, including word frequency, specific word preferences, and unique expressions or jargon, or other features for providing insight into an author's style, where uncommon word choices or habitual use of certain terms can be strong indicators; sentence structure and syntax, e.g. sentence length, complexity, structure such as frequent use of subordinate clauses or passive vs. active voice, or other features for revealing patterns in the author's writing style; punctuation and grammar, e.g. placement, use, and frequency of commas, semicolons, or dashes, or specific grammatical choices such as preference for certain tenses, use of contractions, or particular sentence constructions, or similar; stylistic markers, e.g. features like the use of metaphors, idioms, transitions, or related to the overall tone or mood such as formal, informal, humorous, etc.; N-gram analysis; e.g. comparing the frequency and sequence of two-, three-, or four-word phrases (n-grams) or other features to help identify patterns in how the author constructs sentences and phrases; function word frequency, e.g. frequency of prepositions, conjunctions, or articles; topic modelling, e.g. features related to thematic or subject focus to identify recurring areas of interest or expertise; readability and complexity features, e.g. readability scores and measures of writing complexity such as Flesch-Kincaid grade level or average syllables per word or other features associated with an author’s typical level of sophistication in writing. Target features when comparing, for example, artwork to determine if it's by the same artist comprise: the brushstroke techniques, such as the texture, direction, or pressure applied; colour palette choices or the use of light and shadow, i.e. chiaroscuro; or compositional elements associated with recurring themes, subject matter, or the way space is arranged.

Optionally, the first authorship verification score is determined using a linguistic analysis model trained using one or more historical assignment responses. The linguistic analysis model optionally comprises a plurality of collaborative machine learning models. Examples of linguistic analysis models for obtaining an authorship verification score include: Support Vector Machines (SVM), random forests, neural networks, naïve bayes classifiers, Latent Dirichlet Allocation (LDA) models, Principal Component Analysis (PCA) models, K-Nearest Neighbours (KNNs), ensemble models, N-gram models, Term Frequency-Inverse Document Frequency TF-IDF model, or other suitable models not listed here.

Support Vector Machines can be used to classify text based on various linguistic features. By training an SVM on historical responses, the model can learn to distinguish between different authors based on their unique writing styles. Features such as word frequency, sentence structure, and punctuation can be used as input to the SVM. Random Forests, an ensemble learning method, can be employed to analyze multiple linguistic features simultaneously. By training on a dataset of verified historical responses, the model can learn to identify patterns and discrepancies in new responses, providing an authorship verification score based on the likelihood of a match. Neural Networks, particularly Recurrent Neural Networks (RNNs) and Long Short-Term Memory (LSTM) networks, are well-suited for processing sequential data like text. These models can capture complex patterns in writing style, such as syntax and lexical choices, by learning from historical data. They can provide a robust authorship verification score by comparing the learned patterns with new responses. A Naive Bayes Classifier can be used for text classification tasks, including authorship verification. By calculating the probability of certain features (e.g., word frequency, function word usage) given an author, the model can determine the likelihood that a new response was written by the same author. LDA is a topic modeling technique that can be used to identify thematic patterns in text. By comparing the topic distributions of historical and new responses, the model can help verify authorship based on recurring themes and subject matter. PCA can be used for dimensionality reduction, helping to identify the most significant features that differentiate authors. By transforming the feature space, PCA can highlight the key stylistic markers that are unique to an author, aiding in the verification process. KNN can be used to classify text based on the proximity of feature vectors. By comparing the feature vectors of new responses to those of verified historical responses, the model can determine the likelihood of authorship based on the "closeness" of the writing styles. Ensemble methods, such as combining multiple machine learning models (e.g., SVM, Random Forests, Neural Networks), can improve the accuracy and reliability of authorship verification. By leveraging the strengths of different models, an ensemble approach can provide a more comprehensive analysis of linguistic features. N-gram models analyze the frequency and sequence of word phrases. By comparing n-grams from new responses to those in historical data, the model can identify patterns in sentence and phrase construction that are indicative of an author's style. TF-IDF is a statistical measure used to evaluate the importance of a word in a document relative to a collection of documents. By comparing TF-IDF scores of words in new and historical responses, the model can identify unique lexical choices and vocabulary usage that are characteristic of an author.

Any of these models can be trained on historical assignment responses to extract and compare various linguistic features, ultimately providing an authorship verification score that indicates the likelihood of consistent authorship.

In another example, step 508 comprises step 508-B, where the plagiarism score is determined by comparing the assignment response to data stored in a database, including historical assignment responses, web content, and literature references. For example, the plagiarism score is produced by a plagiarism model configured to identify instances where content has been copied or closely paraphrased from existing sources without proper attribution. These models work by comparing the input, e.g. an input text, against a database of published works, including websites, research papers, articles, and books, e.g. database 104-B. Optionally, the plagiarism model uses sophisticated text-matching techniques to find exact or near-exact matches, and/or employs semantic analysis to detect paraphrased content that retains the original meaning but alters the wording. Further optionally, plagiarism detection models incorporate natural language processing (NLP) to understand context and check for synonym replacement, sentence reordering, or changes in phrasing that could disguise copied material. Examples of popular plagiarism detection tools include Turnitin, Grammarly, and Copyscape, which are widely used in academic, professional, and content creation settings to ensure the originality and integrity of written work.

When step 508 optionally comprises step 508-C, the AI detection model assesses the likelihood of the content being generated using one or more large language models, thereby resulting in an AI detection score. AI detection model of step 508-C is preferably a specialized algorithm. The AI detection model is configured to analyse various linguistic and/or statistical features within an input. For example, when analysing a text input, analysed features comprise syntax patterns, word frequency distributions, sentence structure, or coherence, which may differ between human-authored content and AI-generated text. Optional AI detection models use neural networks trained on large datasets of both human-written and AI-generated content to learn the subtle differences. They may also leverage metadata, contextual clues, and token usage anomalies specific to LLM outputs. Example AI detection models include GPT detectors and others developed by companies like OpenAI or third-party researchers to mitigate misuse of AI, detect plagiarism, or ensure content authenticity in various domains like education, publishing, and cybersecurity.

Step 508 comprises at least one of steps 508-A, 508-B, or 508-C. Optionally, step 508 comprises a combination of any two or all three. Further optionally, step 508 comprises alternative or additional models to those described in steps 508-A, 508-B, or 508-C, where the additional models are used to assess honesty and/or integrity of an assignment submission.

Optionally, step 508 further comprises determining a second authorship verification score, wherein the second authorship verification score is based on comparison of the first assignment response with the answer set. For example, determining the second authorship verification score comprises extracting a first feature value associated with a target feature from the first assignment response, which is the same target feature used for determining the first authorship verification score or another target feature. A second feature value associated with the target feature is extracted from one or more answers of the answer set, and the first feature value is compared to the second feature value, e.g. to determine the likelihood that both the first assignment response and the answer set were authored by the same person. Optionally, multiple target features are used.

Further optionally, step 506 comprises any of the steps of 508 where, instead of the first assignment response being analysed for integrity, the answer set associated with the quest set of 504 is analysed for integrity.

Optionally, step 508 is performed within the first response session, e.g. step 508 is performed simultaneously to step 504. Additionally, or alternatively, step 508 is initiated at the start or the end of the first response session, e.g. step 508 is performed before or after step 504.

Step 510 comprises verifying honesty, and is an optional step of method 500. For example, if the integrity score or an uncertainty associated with the integrity score exceeds a predetermined threshold, authorship honestly is verified and method 500 proceeds to step 512. In another example, step 508 is repeated, e.g. using a different integrity model, resulting in multiple integrity models being used in series. Optionally, multiple integrity models are used in parallel. While this is more computationally extensive, it increases time efficiency. Optionally, step 510 is excluded from method 500, increasing efficiency, and method 500 proceeds from step 508 to step 512.

In Step 512, a report on the submission is generated. This report includes an authorship authentication result associated with the answer set and the integrity score. The result provides a clear and actionable outcome regarding the authenticity of the assignment response, including a detailed analysis of any detected issues such as plagiarism or AI-generated content. The report enables the assessment body to make informed decisions about the examinee's submission, ensuring academic integrity and preventing dishonest practices. This final step consolidates the findings from the previous analyses and optionally provides, stores, or reports them in a format for efficient collation, interpretation and/or decision-making.

Optionally, step 512 further comprises weighting the one or more scores of step 508. For example, the integrity score of step 508 is weighted to reduce false positives, such that examinees are unlikely to be falsely accused of dishonesty. In another example, the plagiarism score is weighted to reduce false negatives, such as in a topic area where plagiarism in a known issue.

Unlike the static cloze-test model described in the prior art, real-time question generation adjusts dynamically based on the text and user responses, providing a more accurate and efficient evaluation. This reduces the need for complex model retraining or high computational overhead, as the system adapts in real-time, optionally minimizing resource-intensive batch processing of entire texts. For example, step 504, and optionally step 506, is repeated based on received answers, or lack of answers, in the answer set based on one or more responses of the examinee. E.g., if a question of the question set was not answered adequately, step 504 optionally further comprises generating a further question to determine authorship.

Further optionally, step 508 is performed before or simultaneously to step 504. For example, step 508 improves system efficiency by narrowing down suspicious sections of the text before deeper analysis is performed, e.g. using any of the steps 508-A, 508-B, 508-C, or 504, thereby reducing unnecessary computations. This combination can be computationally optimized, as it minimizes redundant operations by leveraging shared features across these detection mechanisms, significantly saving processing power and energy in contrast to traditional, isolated systems like the cloze-test method. For example, if a section of the assignment response is determined to have high levels of plagiarism or high likelihood of ai-generated content, questions generated at step 504 are optionally focussed on that section. This improves computationally efficiency, as the entire text does not need to be analysed in either step 508 or step 504, depending on the answers received in relation to that section.

In another embodiment, the result of the integrity analysis step 508 is directed to the automatic question generator to be utilised in performing step 504. For example, the automated question generator can modulate characteristics of the questions in the generated question set (such as quantity and complexity) in accordance with the result of performing the integrity analysis step 508. In this way, the number and complexity of questions presented to the student vary based upon the reliability of authorship estimated when performing the integrity analysis step. That is, for example, a submission where the reliability is high can have fewer question required to validate authorship, but low probability requires more questions.

This embodiment provides an adaptive, closed-loop authentication mechanism that dynamically scales the intensity of question characteristics based on the inherent linguistic properties of the submission as determined during integrity analysis. Unlike statically generated questions that apply a uniform set of challenges to every user, this embodiment implements a preliminary "analysis phase" using linguistic fingerprinting and perplexity testing. This analysis functions as a technical control signal that dictates the operational parameters of the subsequent question-generation phase.

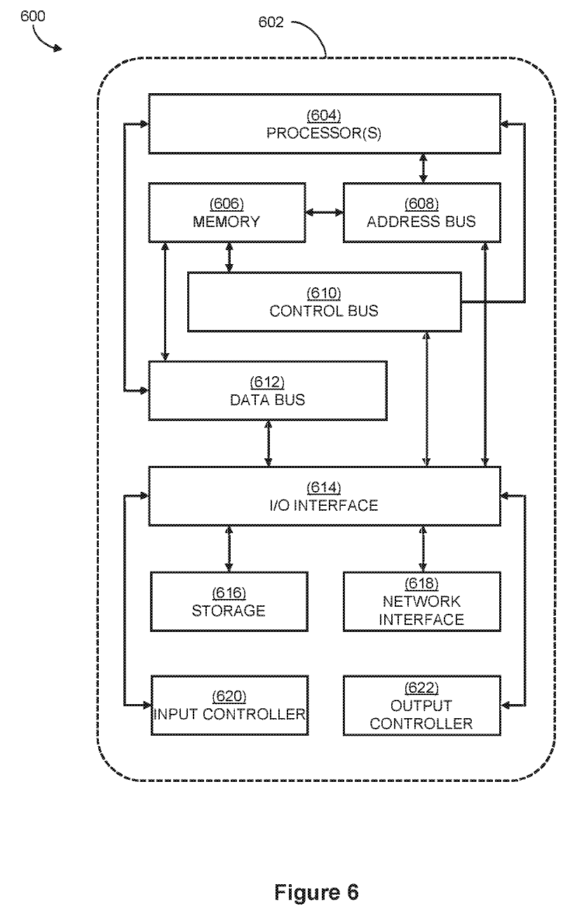

Technically, the system utilises perplexity—a measurement of how "surprising" a sequence of text is to a language model—and linguistic fingerprinting to generate an initial probability score regarding the submission's provenance. This score is then used to programmatically modulate an "authentication budget." For submissions identified as high-reliability (human-likely), the system minimises friction by reducing the number and complexity of generated questions. Conversely, for low-probability submissions (AI-likely or non-authentic), the system automatically escalates the challenge by increasing the volume and cognitive depth of the required responses. FIG. 6 shows an example computing system. Specifically, FIG. 6 shows a block diagram of an embodiment of a computing system 600 according to example embodiments of the present disclosure.

Computing system 600 can be configured to perform any of the operations disclosed herein such as, for example, any of the processes or methods described herein. Computing system 600 includes one or more computing devices 602. Computing device 602 of computing system 600 comprises one or more processors 604 and memory 606. device(s) 602 of computing system 600 comprise one or more processors 604 and memory 606. One or more processors 604 can be any general-purpose processor(s) configured to execute a set of instructions. For example, one or more processors 604 can be one or more general-purpose processors, one or more field programmable gate array (FPGA), and/or one or more application specific integrated circuits (ASIC). In one embodiment, one or more processors 604 include one processor. Alternatively, one or more processors 604 include a plurality of processors that are operatively connected. One or more processors 604 are communicatively coupled to memory 606 via address bus 608, control bus 610, and data bus 612. Memory 606 can be a random-access memory (RAM), a read-only memory (ROM), a persistent storage device such as a hard drive, an erasable programmable read-only memory (EPROM), and/or the like. Computing device(s) 602 further comprise input/output (I/O) interface 614 communicatively coupled to address bus 608, control bus 610, and data bus 612.

Memory 606 can store information that can be accessed by one or more processors 604. For example, memory 606 (e g., one or more non-transitory computer-readable storage mediums, memory devices) can include computer-readable instructions (not shown) that can be executed by one or more processors 604. Alternatively, or additionally, memory 606 can be a combination of information storage and the option to process data in-memory without having to read out the data first and let the processor 604 perform operations on the memory data. For example, in memory computing is optionally used for CTM implementation, e.g. for “weighting” of clauses, where the weights from a trained model are stored in memory and the weighting is automatically performed when a clause evaluates to 1.

The computer-readable instructions can be software written in any suitable programming language or can be implemented in hardware. Additionally, or alternatively, the computer-readable instructions can be executed in logically and/or virtually separate threads on one or more processors 604. For example, memory 606 can store instructions (not shown) that when executed by one or more processors 604 cause one or more processors 604 to perform operations such as any of the operations and functions for which computing system 600 is configured, as described herein. In addition, or alternatively, memory 606 can store data (not shown) that can be obtained, received, accessed, written, manipulated, created, and/or stored. The data can include, for instance, the data and/or information described herein in relation to FIGS. 1-6. In some implementations, computing device(s) 602 can obtain from and/or store data in one or more memory device(s) that are remote from the computing system 600.

Computing system 600 further comprises storage unit 616, network interface 618, input controller 620, and output controller 622. Storage unit 616, network interface 618, input controller 620, and output controller 622 are communicatively coupled to central control unit or computing devices 602 via I/O interface 614.

Storage unit 616 is a computer readable medium, preferably a non-transitory computer readable medium, comprising one or more programs, the one or more programs comprising instructions which when executed by one or more processors 604 cause computing system 600 to perform the method steps of the present disclosure. Alternatively, storage unit 616 is a transitory computer readable medium. Storage unit 616 can be a persistent storage device such as a hard drive, a cloud storage device, or any other appropriate storage device.

Network interface 618 can be a Wi-Fi module, a network interface card, a Bluetooth module, and/or any other suitable wired or wireless communication device. In an embodiment, network interface 618 is configured to connect to a network such as a local area network (LAN), or a wide area network (WAN), the Internet, or an intranet.

FIG. 6 illustrates one example computer system 600 that can be used to implement the present disclosure. Other computing systems can be used as well. Computing tasks discussed herein as being performed at and/or by one or more functional unit(s) can instead be performed remote from the respective system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Regarding the above disclosure, references to items in the singular should be understood to include items in the plural, and vice versa, unless explicitly stated otherwise or clear from the context. Additionally, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. The use of any and all examples, or exemplary language (“e.g.,” “such as,” “including,” or the like) provided herein, is intended merely to better illuminate the embodiments and does not pose a limitation on the scope of the embodiments or the claims.

Methods described herein may relate to a computer storage product with a non-transitory computer-readable medium (also can be referred to as a non-transitory processor-readable medium) having instructions or computer code thereon for performing various computer-implemented operations, such that the methods are performed. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape, optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a transitory computer program product, which can include, for example, the instructions and/or computer code discussed herein.

Some embodiments and/or methods described herein can be performed by software (executed on hardware), hardware, or a combination thereof. Hardware modules include, for example, a general-purpose processor, a field programmable gate array (FPGA), and/or an application specific integrated circuit (ASIC). Software modules (executed on hardware) can be expressed in a variety of software languages (e.g., computer code), including C, C++, Java, Ruby, Visual Basic, Python, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code. Optionally, the embodiments and/or methods described herein are implemented using an operating system such as Robot Operating System (ROS).

Any of the above-described embodiments in relation to FIGS. 1-6 or features disclosed herein can be combined, and the skilled person would understand such examples do not limit the potential embodiments of the present disclosure.

The skilled person will also understand that any use of “or” throughout the claims or description herein encompasses use of “or”, “and/or”, and “and”. For example, the term "or" within the discourse is construed to encompass both "and" and "and/or" owing to its inherent inclusivity. Within linguistic reasoning, "or" denotes an inclusive disjunction, allowing for the consideration of scenarios wherein either one condition holds true, the other condition holds true, or both conditions hold true concurrently. This interpretation inherently incorporates the conjunction "and", permitting the acknowledgment of scenarios wherein multiple conditions coexist. Additionally, the term "and/or" explicitly acknowledges the possibility of either condition being singularly true or both conditions being true simultaneously, thus aligning with the broader meaning of "or" within the context of this disclosure. Consequently, "or" functions as a flexible connector, accommodating both exclusive and inclusive interpretations to suit the nuanced requirements of embodiments described herein.

1. A method for authenticating authorship, the method comprising:
within a first response session:
receiving a first assignment response associated with an examinee;
generating, using an automated question generator, a question set comprising one or more questions based on the first assignment response;
communicating the question set to the examinee and, in response, receiving an answer set from the examinee associated with at least one question of the question set;
obtaining an integrity score based on analyzing the first assignment response for academic integrity by determining at least one of:
a first authorship verification score based on comparison of the first assignment response with at least one verified assignment response authored by the examinee;
a plagiarism score associated with a level of plagiarized content detected within the first assignment response; or
an AI detection score associated with the level or likelihood of content within the first assignment response being generated using one or more large language models; and
outputting an authorship authentication result associated with the answer set and the integrity score for determining whether the examinee authored the first assignment response.

2. The method of claim 1, wherein determining the first authorship verification score comprises:
extracting a first feature value associated with a target feature from the first assignment response;
extracting a second feature value associated with the target feature from the at least one verified assignment response; and
comparing the first feature value to the second feature value.

3. The method of claim 1, wherein determining the first authorship verification score further comprises determining a second authorship verification score, wherein the second authorship verification score is based on comparison of the first assignment response with the answer set.

4. The method of claim 1, wherein the first authorship verification score is determined using a linguistic analysis model trained using one or more historical assignment responses.

5. The method of claim 4, wherein the linguistic analysis model comprises a plurality of collaborative machine learning models.

6. The method of claim 1, wherein the plagiarism score is determined by comparing the first assignment response to one or more works stored on a database.

7. The method of claim 1, wherein the automated question generator is configured to output one or more questions relevant to an input, and wherein the input comprises any of: the first assignment response; an academic or scientific reference; subject matter associated with the first assignment response; curriculum data; a historical assignment response; or any combination thereof.

8. The method of claim 1, wherein the automated question generator comprises a generative machine learning model.

9. The method of claim 1, wherein the one or more questions of the question set are generated in real-time or near real-time relative to receiving the first assignment response.

10. The method of claim 1, wherein:
the question set is communicated to the examinee within a first predetermined time interval; or
an answer of the answer set is received within a second predetermined time interval after generating the question set.

11. The method of claim 1, further comprising performing an analysis of the answer set and, based on the analysis, selecting whether to determine the first authorship verification score, the plagiarism score, or the AI detection score.

12. The method of claim 1, wherein obtaining the integrity score comprises determining a combination of the first authorship verification score, the plagiarism score, or the AI detection score.

13. The method of claim 1, wherein the method is performed at an authentication device.

14. The method of claim 1, wherein the automated question generator utilises the integrity score to generate a question set.

15. The method of claim 14, wherein the utilising comprises the automated question generator modulating at least one characteristic of questions in the generated question set in accordance with the integrity score.

16. The method of claim 15, wherein the characteristic comprises question quantity and question complexity.

17. The method of claim 14, wherein the utilising comprises the automated question generator focussing question generation on sections of the assignment response shown when obtaining the integrity score to have high levels of plagiarism or high likelihood of ai-generated content.

18. A non-transitory computer-readable medium storing instructions for performing the method of claim 1.

19. An authorship authentication system configured to output an authorship authentication result for determining whether an examinee authored a first assignment response, the authorship authentication system comprising:
an automated question generator configured to generate a question set comprising one or more questions, wherein:
the question set is associated with the first assignment response submitted by the examinee; and
the question set is provided to the examinee within a predetermined time interval after the authorship authentication system receives the first assignment response;
one or more integrity models configured to obtain an integrity score, wherein the integrity score is based on analyzing the first assignment response for academic integrity, the one or more integrity models comprising any of:
an authorship verification model configured to determine a first authorship verification score based on comparison of the first assignment response with a verified assignment response authored by the examinee;
a plagiarism model configured to determine a plagiarism score associated with a level of plagiarized content detected within the first assignment response; or
an AI detection model configured to determine an AI detection score associated with the level or likelihood of content within the first assignment response being generated using one or more large language models.
